(19) United States
(12) Patent Application Publication
(10) Pub. No.: US 2022/0143688 A1
(43) Pub. Date: May 12, 2022

(54) ELECTROMAGNETIC DEVICE AND SYSTEM FOR PUMPING, CIRCULATING OR TRANSFERRING NON-FERROUS MOLTEN METAL

(71) Applicant: EMP TECHNOLOGIES LIMITED, Burton-on-Trent (GB)

(72) Inventors: Paul BOSWORTH, Burton-on-Trent (GB); Robert FRITZSCH, Trondheim, Trøndelag (NO); Jason MIDGLEY, Burton-on-Trent (GB)

(21) Appl. No.: 17/437,951

(22) PCT Filed: Mar. 11, 2020
(86) PCT No.: PCT/GB2020/050615

§ 371 Date: Sep. 10, 2021

(30) Foreign Application Priority Data
Mar. 11, 2019 (GB) 1903320.8

(51) Int. Cl. B22D 39/00; H02K 44/06

(52) U.S. Cl. CPC B22D 39/006; H02K 44/06

(57) ABSTRACT

An electromagnetic device for pumping, circulating or transferring non-ferrous molten metal has a duct made of a refractory material with a first aperture at a first end of the duct and a second aperture at a second end of the duct. The duct conveys a body of non-ferrous molten metal between the first and second apertures. The duct encloses the body of non-ferrous molten metal between the first and second apertures. The duct has opposing first and second external side surfaces. A first inductor assembly extends adjacent to the first side surface. The first inductor assembly comprises a plurality of inductors arranged along a length of the duct adjacent to the first side surface. An electronic circuit generates direct current pulses that energise each inductor of the plurality of inductors in a sequence, so as to generate a moving magnetic field within the body of non-ferrous molten metal which propels the body of non-ferrous molten metal along the duct.

### FIELD OF THE INVENTION

The present invention relates to an electromagnetic device for pumping, circulating or transferring non-ferrous molten metal. The present invention also relates to a system comprising a vessel for holding a body of non-ferrous molten metal, a channel connected by at least one end to a first opening in the vessel and an electromagnetic device for pumping, circulating or transferring the non-ferrous molten metal along the channel.

### BACKGROUND OF THE INVENTION

When melting non-ferrous metals (such as aluminium and its alloys) during production or recycling, electromagnetic pumps can be used to pump, circulate and transfer the molten metals. For example, the electromagnetic pumps may be used to circulate the molten metal within the furnace to ensure an even distribution of alloys and a more homogeneous temperature distribution through the body of molten metal (since natural convection alone is not sufficient to overcome the temperature gradient between the furnace floor and the heated metal surface).

GB 2,515,475 A describes such a circulating system where an open topped channel called a launder is connected at both ends to the furnace. A pump is placed in the centre of the launder to pump molten metal from the furnace through the launder and back into the furnace thereby causing the molten metal to circulate and mix.

An electromagnetic pump may also be used to transfer material. For example, US 2018/0216890 A1 describes pumping molten metal into a launder which has a dam arranged to selectively open and close an outlet for removing molten metal from the launder, for example, for further processing or casting.

Existing electromagnetic pumps typically comprise a tube made of refractory material through which the molten metal can flow. A layer of insulation is wrapped around the outer circumference of the tube and a plurality of inductor coils are wrapped around the insulation. The inductor coils may be energised to generate a magnetic field that propels the molten metal along the tube. The insulation helps to prevent heat from the molten metal in the tube from damaging the inductor coils. The design of existing electromagnetic pumps (with the inductor coils and insulation wrapped on top of one another around the tube) makes it difficult to access the inductor coils for maintenance. If one of the inductor coils develops a fault and needs replacing, the entire electromagnetic pump usually has to be decommissioned and dismantled, leading to costly downtime.

Tubes with a larger inner diameter (bore) are preferred for electromagnetic pumps because the throughput of an electromagnetic pump is determined in part by the inner diameter of the tube, and also because having a larger inner diameter makes access and maintenance from the furnace side easier. Tubes with smaller inner diameters, while beneficial for high frequency (that is, mains frequency) operation, will restrict the throughput, and will also lead to increased interactions between the molten metal and the inner walls of the tube, increasing a number of undesirable effects including heat loss and chemical reactions with the inner walls. A smaller inner diameter also increases the chance that the molten metal will freeze to the inner walls which can ultimately lead to costly downtime to clear the blocked tube. A tube with a smaller inner diameter holds a smaller volume of metal and has a higher surface-to-volume ratio, meaning that in the event of a system failure the temperature of the volume of metal drops faster, increasing the likelihood the molten metal will freeze.

However, making the inner diameter of the tube large enough to avoid these undesirable effects causes challenges with generating a magnetic field of sufficient strength to penetrate into the centre of the tube in order to propel the molten metal across the whole tube diameter. The magnetic field applied in existing electromagnetic pumps is usually not sufficient to propel the molten metal across the whole tube diameter and only the molten metal nearest the tube walls will experiences the force provided by the moving magnetic field. As a result, the molten metal in the centre of the tube will usually be carried along by drag forces, but the drag forces may be insufficient to carry the molten metal in the centre of the tube along (particularly if, for example, the molten metal is being pumped against gravity or a back pressure) resulting in an effect called slippage, where the molten metal in the centre of the tube may flow backwards. Slippage is an issue for existing electromagnetic pumps which causes an undesirable drop in the output pressure and pumping capacity of existing electromagnetic pumps.

As the diameter of the bore of a circular cross-section tube increases, the electromagnetic field strength required to move the molten metal across the full diameter of the tube while avoiding slippage increases. In existing electromagnetic pumps there is usually a trade-off between the inner diameter of the tube and an achievable magnetic field that can be generated by the coil even at substantial power. It becomes difficult and expensive to create a power supply that can provide enough power to the coil to generate a sufficient magnetic field to propel molten metal across the full bore diameter and avoid slippage (particularly when the power supply is limited to typical mains frequency at 50 Hz-60 Hz).

The tube is carrying molten metal at high temperatures, and the outer surface of the tube gets extremely hot which could damage the inductor coil if it is placed too close to the tube and adequate cooling is not supplied. Typically, some insulation is provided between the outer surface of the tube and the inductor coils. However, providing insulation displaces the inductor coils from the tube, increasing the magnetic field that must be provided to propel the liquid metal across the full bore diameter to avoid slippage and the power supply required to generate the magnetic field. Insufficient (thin) thermal insulation increases the risk of transferring heat directly from the hot metal into the cooled coil. Providing sufficient cooling within the constrained geometry of existing electromagnetic pumps is challenging and limits how much existing pump designs can be scaled up. When coils do fail, the problems with repairing them arise again, leading to costly downtime.

GB 2,515,475 A1 suggested that an electromagnetic pump might be created by placing an induction element, such as a set of coils around a base and one or more sides of an open-topped launder. This arrangement can achieve some circulation of the molten metal, but it is inefficient. In an open-topped launder, it is not possible to generate pressure in the molten metal required for transferring the molten metal. Applying a force to molten metal in an open-topped launder just tends to generate waves which could cause molten metal to splash over the top of the launder.

It would, therefore, be desirable to overcome at least some of the limitations with existing electromagnetic pumps.

### SUMMARY OF INVENTION

According to a first aspect of the invention, there is provided an electromagnetic device for pumping, circulating or transferring non-ferrous molten metal. The electromagnetic device comprises a duct having a first aperture at a first end of the duct and a second aperture at a second end of the duct. The duct is configured to convey a body of non-ferrous molten metal between the first and second apertures. The duct is configured to enclose the body of non-ferrous molten metal between the first and second apertures (that is, the duct wraps all the way around the body of non-ferrous molten metal such that the only openings in the duct are the first and second apertures). The duct has opposing first and second external side surfaces. A first inductor assembly extends adjacent to the first side surface, wherein the first inductor assembly comprises a plurality of inductors arranged along a length of the duct adjacent to the first side surface. An electronic circuit is configured to energise each inductor of the plurality of inductors in a sequence, so as to generate a moving magnetic field within the body of non-ferrous molten metal which propels the body of non-ferrous molten metal along the duct.

Prior art electromagnetic pumps have a plurality of inductor coils, but each inductor coil is circular and wrapped all the way around the outer circumference of a circular tube conveying the molten metal, often with the inductor coils physically attached or coupled to the tube or insulation surrounding the tube. This makes accessing an inductor for maintenance difficult. If one of the inductor coils develops a fault and needs replacing, the entire electromagnetic device usually has to be decommissioned and dismantled, leading to costly downtime of the whole furnace or melting equipment.

In contrast, in the present invention, the duct is outside any of the coils. That is to say, none of the coils are wrapped all the way around the outside of the duct, nor are any of the inductor coils or the inductor assembly physically attached or in any way physically coupled to the tube or the insulation surrounding the tube. Instead, the inductors are located in an assembly that is adjacent to just one side surface of the duct, with a gap between the inductor assembly and the tube or the insulation surrounding the tube. This physical separation between the inductor assembly and the tube or insulation surrounding the tube makes it much easier to swap a faulty inductor assembly for a working one.

For example, the entire inductor assembly may be attached to a slider which allows the faulty inductor assembly to be slid out and a new assembly slid in, without needing to dismantle the entire device. Also, as the electromagnetic device can operate with just a single inductor assembly, this arrangement provides the possibility of providing inductor redundancy since a second inductor assembly can be provided adjacent to the second side surface, and if one of the inductor assemblies is removed for repair, the electromagnetic device will still work with a single inductor assembly.

A gap between the body of non-ferrous molten metal and the first inductor assembly (for example, between facing outer surfaces of the non-ferrous molten metal and the inductors of the first inductor assembly) may be more than one of: 75 mm, 100 mm, 150 mm, 200 mm and 250 mm. This gap is larger than existing electromagnetic pumps, making it possible to fully separate the inductor assembly from the coil and any insulation surrounding the coil for easier maintenance, and allowing more insulation to be provided.

This larger gap is possible because the inventors have found that using low frequency direct current pulses (such as 0.5 to 100 direct current pulses per second, or 0.1 to 100 direct current pulses per second) to energise the inductors rather than mains frequency alternating current (50-60 Hz) as used in existing electromagnetic pumps has allowed them to increase the penetration depth of the magnetic field into the duct allowing for a larger gap between the inductors and the duct while still avoiding slippage.

To make the tube bore large enough to avoid the undesirable effects of small bore tubes, the penetration depth and magnetic force needs to be increased. If the penetration depth is not sufficient, unwanted slippage may occur. In prior art electromagnetic pumps there is usually a trade-off between the bore diameter and an achievable penetration depth of the magnetic field generated by the coil because as the diameter of the bore of a circular cross-section tube increases, the required penetration depth correspondingly increases. Additionally, the refractory, e.g. the thermal insulation needs to increase accordingly. It becomes expensive to create a power supply that can provide enough power to the coil to generate a sufficient penetration depth to propel liquid metal across the full bore diameter and avoid slippage (particularly when the power supply is limited to typical mains frequency at 50 Hz-60 Hz).

The geometry of the electromagnetic device of the present invention helps to increase the inner area of the duct to increase throughput without necessarily requiring a corresponding increase in penetration depth, which helps to reduce the power required when compared to a prior art electromagnetic pump with circular coils, making the electronic circuit cheaper to manufacture. By having a plurality of inductors extending along only one of the external side surfaces of the duct, rather than having the inductors as coils wrapped around the entire outer circumference of the duct, the duct no longer needs to have a circular cross-section dictated by the coil geometry.

Instead, the duct can have a shape which is optimised for both penetration depth and pumping capacity simultaneously, such as a wide, flat shape. For example, a cross-section through the duct may have a height between the first and second side surfaces which is less than a width of the cross-section across the duct. The width of the cross-section may be at least as wide as the width of the adjacent inductors (to maximise overlap between the inductor assembly and the side surface) while the height of the cross-section of the duct may be less and selected according to the penetration depth of the electromagnetic field generated by the inductor (for example, to allow a sufficient magnetic field to penetrate all the way through the body of non-ferrous molten metal so that the entire body of non-ferrous molten metal is propelled by the magnetic field to avoid slippage). Therefore, the geometry of the electromagnetic device of the present invention provides a way that penetration depth and pumping capacity may be optimised simultaneously.

One example of a possible cross-sectional shape for the duct is a substantially rectangular cross-section where the inductor assembly is adjacent to one of the longer side surfaces of that rectangular cross section of the duct (to maximise overlap between the inductor assembly and the side surface) while the shorter side of the rectangular cross-section of the duct can be selected according to the penetration depth of the electromagnetic field generated by the inductor.

The magnetic field may be configured to have a penetration depth of at least one of: 50 mm, 100 mm, 200 mm, 300 mm, 400 mm, 500 mm and 1000 mm. Such penetration depths are higher than can be achieved in prior art electromagnetic pumps and are possible as a results of the low frequency direct current pulses energising the inductors. This high penetration depth allows the inductors to be placed relatively far away from the duct compared to existing electromagnetic pumps, improve access for maintenance and permitting additional insulation.

In contrast, given the practical limitations on achievable penetration depth in existing electromagnetic pumps as a result of them being fixed at 50-60 Hz main frequency, the coil cannot be located too far from the outer surface of the tube. The tube is carrying molten metal at high temperatures, and the outer surface of the tube gets extremely hot which can cause problems if adequate cooling is not supplied to the coil. Local super heating of the coils caused by resistance to the current driving the coil (particularly for alternating driving currents) could locally melt or even vaporize the coil. To prevent this, the coil is cooled. However, typical coolants boils at lower temperatures, e.g. in the range of 80° C.-200° C. which is far below the temperature of 700 to 900° C. for aluminium at the outer surface of the tube, which presents the challenge of preventing the coolant from boiling which could damage the coil by vapour expansion. Water leakage into the liquid metal stream can cause fatal failure of the equipment, as water and liquid aluminium can cause liquid metal water explosions. Providing sufficient cooling in the constrained geometry of existing electromagnetic pumps is challenging. It is not practical to provide additional insulation because this just makes the penetration depth problem worse.

The geometry of the electromagnetic device of the present invention, in particular that the duct can have a wide flat shape to reduce the required penetration depth while simultaneously providing the required level of throughput, helps to space the inductor assembly further from the duct to reduce the heat load to ambient on the inductor assembly cooling system.

GB 2,515,475 A1 suggested that an electromagnetic pump might be created by placing an induction element, such as a set of coils around a base and one or more sides of an open-topped launder. This arrangement can achieve some circulation of the molten metal but it is inefficient. However, in an open-topped launder, it is not possible to generate pressure in the molten metal required for transferring the molten metal. Applying a force to molten metal in an open-topped launder just tends to generate waves which could cause molten metal to splash over the top of the launder. In contrast, in the present invention, the duct encloses the body of metal on all sides and the magnetic field acts like a piston pushing the molten metal out of the exist aperture, which acts to cause a pressure head of molten metal at the exit aperture.

The electromagnetic device may further comprise a second inductor assembly extending adjacent to the opposing second side surface. The second inductor assembly may comprise a plurality of components arranged along a length of the duct adjacent to the second side surface.

The electromagnetic device may further comprise electrical contacts inserted into the body of non-ferrous molten metal (for example, electrical contacts inserted either side of the duct). A direct current may be applied to the contacts to interact with the magnetic field induced in the body of non-ferrous molten metal in order to increase the propulsion of the body of non-ferrous molten metal along the duct.

Each of the components may be one or more of an inductor and a magnetic core. That is, each of the components may be an inductor alone, a magnetic core alone, or a combination of an inductor and a magnetic core.

Each of the inductors adjacent to the first side surface may opposes one of the components adjacent to the second side surface, (e.g. a mirrored design with the metal in the centre as the mirror axis). Therefore, the electromagnetic device has a plurality of inductors on one side of the duct, adjacent to the first side surface. On the other side of the duct, adjacent to the second side surface, is a corresponding component. Each inductor may directly oppose its corresponding component (an inductor and/or a magnetic core). The component helps to direct the magnetic field across the duct, most effectively where the component comprises an inductor.

Each inductor may comprise a coil wrapped around a magnetic core. For example, the coils may comprise copper or aluminium. The coils may be hollow to allow a cooling medium (such as water or oil) to pass through the coil for internal cooling. Alternatively, the coils may be solid and external cooling may be provided, for example, air cooling, or by immersing the coils in a cooling bath (such as an oil bath).

The magnetic core may comprise a ferrimagnetic material or a ferromagnetic material. For example, the magnetic core may comprise iron or ferritic steel.

Each of the inductors on a side of the duct may be wrapped around a single magnetic core that extends along the length of that side of the duct. Having a single magnetic core make manufacturing easier, for example, requiring the mounting and alignment of only a single component. Also, having a single magnetic core allows magnetic flux to circulate around the entire magnetic core (including neighbouring projections). This improves efficiency when switching between inductors and reduces the load.

The single magnetic core may comprise a base that extends along the length of the side of the duct and a plurality of projections extending from the base. Each coil may extend around one of the projections. The projections may provide a convenient way to fix each coil. In addition, the projections concentrate the magnetic field induced in the projection by its coil. The projections helps to shape and direct the magnetic field into the duct.

The projections may extend towards the external surface of the duct.

The coils extending around neighbouring projections may be offset. Offsetting the coils on neighbouring projections (at different position along the length of the projection) allows neighbouring coils to be stacked, reducing the length of a magnetic core which can accommodate all of the coils, thereby reducing the overall length of the device.

The coils extending around neighbouring projections may be diagonally offset. Diagonally offsetting the inductors avoids offsetting inductors at different distances from the duct (which could vary the magnetic field applied to the body of molten metal by each inductor). Diagonally offsetting the inductors avoids this while still reducing the overall length of the device.

The magnetic core may have a laminated structure. This reduce eddy current generation.

The laminated structure may comprise sheets of magnetic material separated by an insulating material. The insulating material may comprise one or more materials, such as air, silicates and/or polymers. The sheets of magnetic material may be separated by spacers made of insulating material.

The inductors may be air, vapour or liquid cooled. The liquid may be, for example, water, glycol, or an explosion-proof liquid (to prevent explosion in the event of contact with a hot surface or molten metal).

The electronic circuit may generate an alternating current pulse to energise each inductor.

The electronic circuit may be configured to generate a direct current pulse to energise each inductor. Penetration depth into the molten metal in the duct is related to the frequency of the magnetic field, e.g. the speed of changing phases, with a low frequency increasing the penetration depth into the material. AC pulses are either restricted to mains frequency (50 Hz-60 Hz) or require frequency conversion which can generate unwanted noise and involves bulky, expensive electronics. AC supplies also tend to generate a large amount of waste heat. In contrast, DC pulses of any desired frequency can be generated by converting the AC mains supply to DC using a rectifier which is supplied to modified switches, (e.g. based on IGBT and thyristors), controlling the supply to each inductor.

Each pulse may have a pulse length in the range of 10 and 10000 milliseconds.

The electronic circuit may generate between 0.5 and 100 pulses per second, preferably 0.1 to 100 pulses per second.

Lower frequencies, readily possible with a DC electronic circuit design in particular, provides higher penetration depth allowing the inductor assemblies to be placed further from the duct. As a result, the inductor assemblies are less likely to be damaged by heat from the molten metal in the duct and there is sufficient space to insert insulation between the duct and the inductor assembly to help prevent heat from reaching the inductor assemblies. Since the inductor assembly is less likely to be affected by heat from the molten metal in the duct, the cooling system for the inductor assemblies only needs to deal with waste heat from the inductors.

An insulation layer may be interposed between an inductor assembly and the duct.

Unlike existing electromagnetic pumps, the inductor assembly is not physically coupled to the duct or to insulation surrounding the duct. As a result, the inductor assembly can be removed without removing the duct or insulation surrounding the duct, making maintenance quicker and more straightforward.

The insulating layers ensure that the outer surface of the electromagnetic device is safe to touch. They also ensure that the inductor assemblies are not adversely affected by the heat from the molten metal, for example, preventing coolant from boiling which might lead to damaging vapour expansion.

An insulation layer may be interposed between the first inductor assembly and the duct. An insulation layer may be interposed between the second inductor assembly and the duct. The insulation layer may comprise a thermally insulating ceramic. Each insulation layer may comprise two sublayers made from different materials. For example an inner layer closest to the duct may comprise a less insulating ceramic with robust physical characteristics (such as, Greenlite, or plates of strong refractory insulation), while the outer layer further from the duct may comprise a more insulating ceramic with weaker physical characteristics (such as, Wollite or castable refractory cement). A holder, which may be made from metal, protects the insulation from damage.

The inside corners of the duct may be rounded, to improve the homogeneity of the flow and reduce the likelihood that the duct (which is usually made of a ceramic refractory material) will crack in the corners under the influence of the high temperature molten metal.

The duct may be made of a refractory material. For example, fused silica, silicon carbide and silica nitride. Silicon carbide may be preferred as it has good thermal conductivity which allow the heat from an attached furnace to preheat the duct, eliminating the need for separate pre-heating hardware and improving the lifetime of the refractory material by preventing thermal shocks.

The non-ferrous molten metal may be one of aluminium, zinc, silicon, magnesium and lead or an alloy comprising one or more of these metals, optionally with one of more additional elements.

According to a second aspect of the invention, there is provided a system comprising a vessel for holding a body of non-ferrous molten metal and a channel connected by at least one end to a first opening in the vessel. An electromagnetic device according to the first aspect is configured to cause molten metal to flow along the channel.

The first aperture of the electromagnetic device may be connected to a second opening in the vessel. The second aperture of the electromagnetic device may be connected to the channel. The electromagnetic device may be configured to propel the body of non-ferrous molten metal along the duct towards the first aperture (that is, from the channel into the vessel).

This causes non-ferrous molten metal to be injected directly into the vessel by the electromagnetic device. This prevents a problem which might occur if the molten metal were instead pumped in the opposite direction, (i.e., around the channel). Accelerating the molten metal towards the relatively small first opening back into the vessel could result in a large amount of splash-back upon reaching the first opening, reducing flow rate towards a fully developed turbulent flow field with less surface entrainment, similar to a laminar flow. Therefore, the more efficient way of circulating molten metal is by pumping it directly back into the vessel and allowing the molten metal to flow through the vessel and back into the channel. Circulating the molten metal in this way acts to stir the molten metal in the vessel helping to make the temperature distribution in the vessel more homogeneous, ensuring thorough mixing of alloys, reducing dross formation and improving melting efficiency.

The channel may comprise an outlet to selectively permit molten metal to be removed from the channel. The electromagnetic device may be configured to cause molten metal to flow towards the outlet. In transfer operations such as this, the electromagnetic device may operate in the opposite direction, propelling the body of non-ferrous molten metal along the duct towards its first aperture and into the channel.

### BRIEF DESCRIPTION OF THE DRAWINGS

The invention shall now be described, by way of example only, with reference to the accompanying drawings in which:

FIG. 1 illustrates a three-dimensional cross-section view of an electromagnetic device for pumping, circulating or transferring non-ferrous molten metal according to an embodiment of the invention;

FIG. 2 illustrates a side view of the cross-section of FIG. 1;

FIG. 3 illustrates an assembly comprising a plurality of inductors made up of coils wrapped around a magnetic core;

FIG. 4 illustrates an example of the construction of the magnetic core in more detail;

FIG. 5 illustrates an electronic circuit for energising the inductors to generate a moving magnetic field that propels a body of non-ferrous molten metal;

FIG. 6 illustrates an example of a moving magnetic field;

FIG. 7 illustrates penetration depth of a magnetic field as a function of frequency for a number of materials; and

FIG. 8 illustrates a plan view of the electromagnetic device of FIG. 1 connected to a chamber and a channel for pumping, circulating or transferring non-ferrous molten metal.

### DETAILED DESCRIPTION

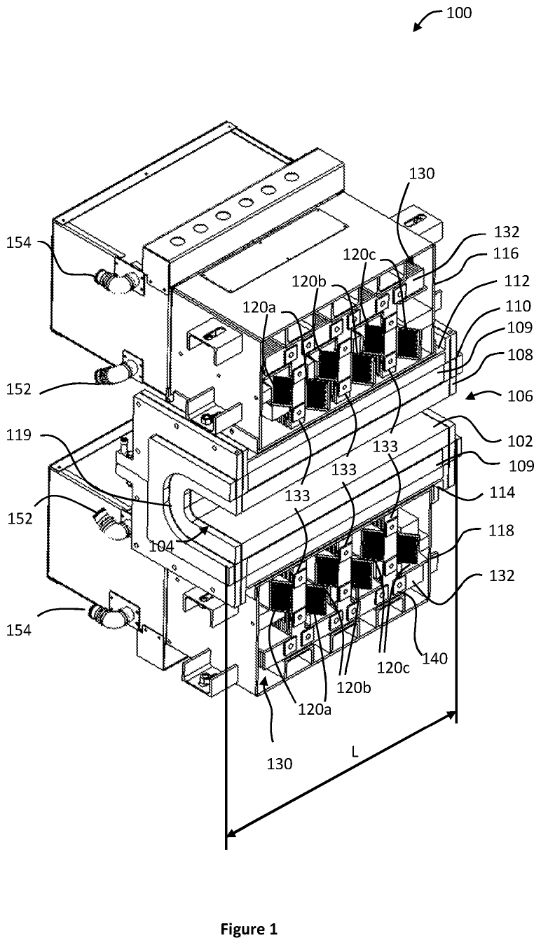

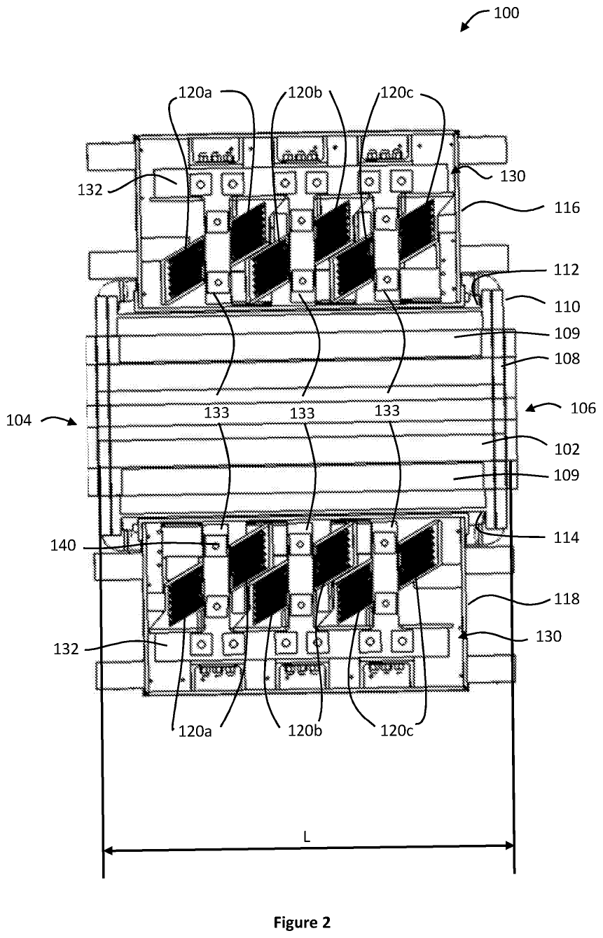

FIGS. 1 and 2 illustrate a cross-section through the centre of an electromagnetic device 100 for pumping, circulating or transferring non-ferrous molten metal. The electromagnetic device 100 has a duct 102 formed of a refractory material 108 such as silicon carbide, which is able to resist the heat of the molten metal without melting or damage. The refractory material 108 is housed within a holder 110. The holder 110 protects the refractory material 108 from damage and provides a way for mounting refractory material 108 in the electromagnetic device 100. The holder 110 is made from metal and in this example is formed in two parts (an upper part and a lower part) to facilitate mounting around the refractory material 108.

The duct 102 has a first aperture 104 at a first end of the duct 102 and a second aperture 106 at the opposite end of the duct 102. The duct 102 has opposing first and second external side surfaces 112, 114. A first inductor assembly 116 extends adjacent to only the first external side surface 112. A second inductor assembly 118 extends adjacent to only the second external side surface 114.

Ceramic insulation material 109 is placed between the duct 102 and the surfaces of the holder 110 adjacent to the first and second inductor assemblies 116, 118, in order to protect the first and second inductor assemblies 116, 118 from the heat of the molten metal in the duct 102.

Each of the inductor assemblies 116, 118 comprise a plurality of inductors 120 arranged along the length of the duct adjacent to the respective side surface. For example, first inductor assembly 116 comprises a plurality of inductors 120a, 120b, 120c adjacent to the first side surface 112 of the duct 102. Second inductor assembly 118 comprises a plurality of inductors 120a, 120b, 120c which mirror the inductors in the first inductor assembly 116. That is, each inductor 120 in the first inductor assembly 116 has a corresponding inductor 120 in the second inductor assembly 118 that opposes it on the opposite side of the duct 102. Specifically, inductor 120a in the first inductor assembly 116 opposes inductor 120a in the second inductor assembly 118, inductor 120b in the first inductor assembly 116 opposes inductor 120b in the second inductor assembly 118, and inductor 120c in the first inductor assembly 116 opposes inductor 120c in the second inductor assembly 118

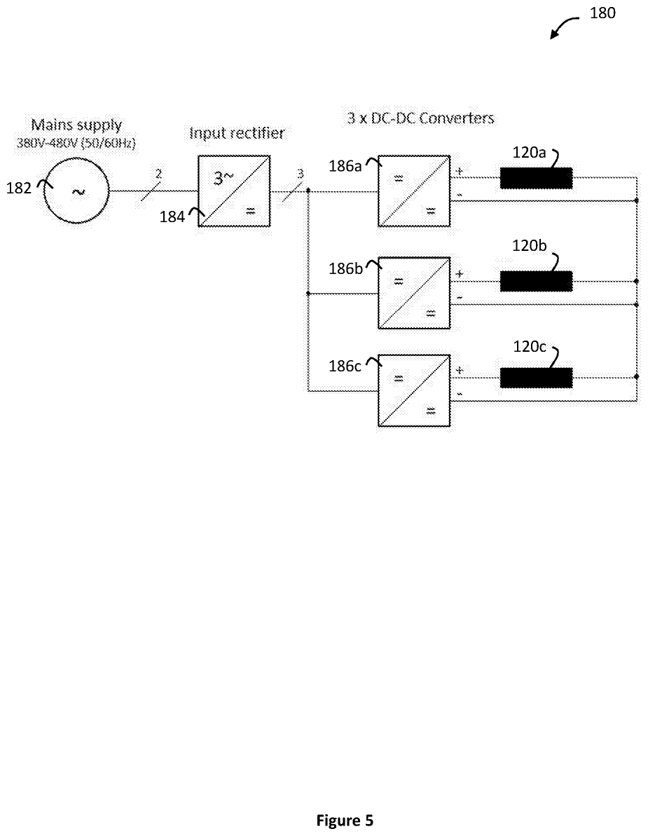

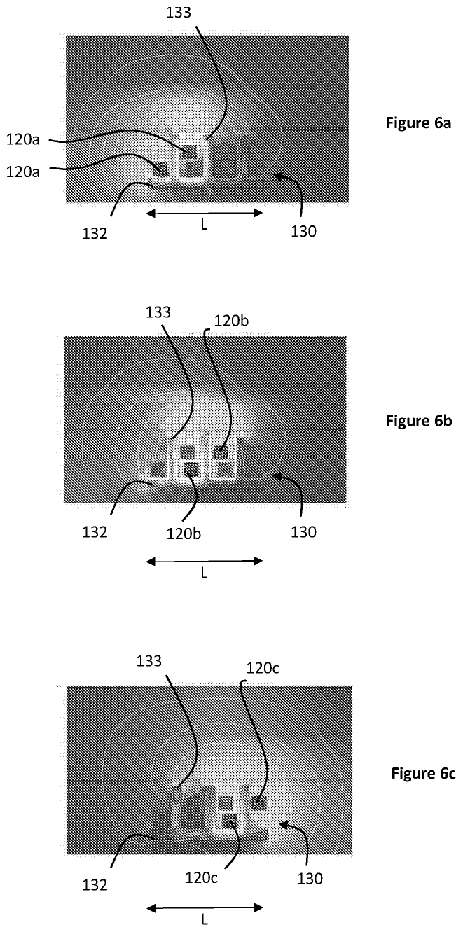

An electronic circuit (shown in detail in FIG. 5) energises each of the inductors 120a, 120b and 120c in turn in order to generate a moving magnetic field which moves along the length of the duct (as illustrated by FIG. 6) in order to propel a body of non-ferrous molten metal along the duct 102 between the first aperture 104 and the second aperture 106.

By having a plurality of inductors 120 extending along only the top and bottom external side surfaces 112, 114 of the duct 102, rather than having the inductors as coils wrapped around the entire outer circumference of the duct 102, the duct 102 no longer needs to have a circular cross-section dictated by the coil geometry. Instead, the duct 102 can have a cross-sectional shape which is optimised for both penetration depth and pumping capacity simultaneously. In this example, the duct 102 has a substantially rectangular cross-section where the inductor assemblies 116, 118 are adjacent to the longer sides (width) of the rectangular cross section of the duct 102, to maximise overlap between the inductor assemblies 116, 118 and the side surfaces 112, 114 respectively. The shorter sides 119 (height) of the cross-section of the duct 102 can be selected according to the penetration depth of the magnetic field generated by the inductors 120 (to allow the magnetic field to penetrate through the entire duct 102).

You will note that in this example, the refractory material 108 of the duct 102 has rounded internal corners. The rounded internal corners improve flow of the molten metal along the duct 102, reducing regions with little or no flow, and avoiding sharp corners to reduce the likelihood that the refractory material will crack under the intense heat of the molten metal (thermal shock).

The first and second inductor assemblies 116, 118 may be fitted to sliders (not shown) which allow them to be slid easily in and out of position to facilitate maintenance. Although the device 100 is shown with two inductor assemblies in place, the device 100 can work adequately with only a single inductor assembly in place. Therefore, one of the inductor assemblies can be removed for maintenance without having to decommission the entire process the device is connected to.

The duct 102 is configured to surround and enclose the body of non-ferrous molten metal on all sides, all the way around the circumference of the duct 102, with the only openings being the first and second apertures 104, 106 at either end of the duct 102. This contrasts to the open-topped launder design seen in other circulating devices where inductors are placed adjacent to the base and one or more sides of an open-topped launder. However, in an open-topped launder, it is not possible to generate pressure in the molten metal required for transferring the molten metal. Applying a force to molten metal in an open-topped launder just tends to generate velocity and waves which could cause molten metal to splash over the top of the launder. In contrast, having the duct 102 enclose the body of molten metal on all sides, the magnetic field acts like a piston pushing the molten metal out of the exit aperture, which acts to cause a pressure head of molten metal at the exit aperture.

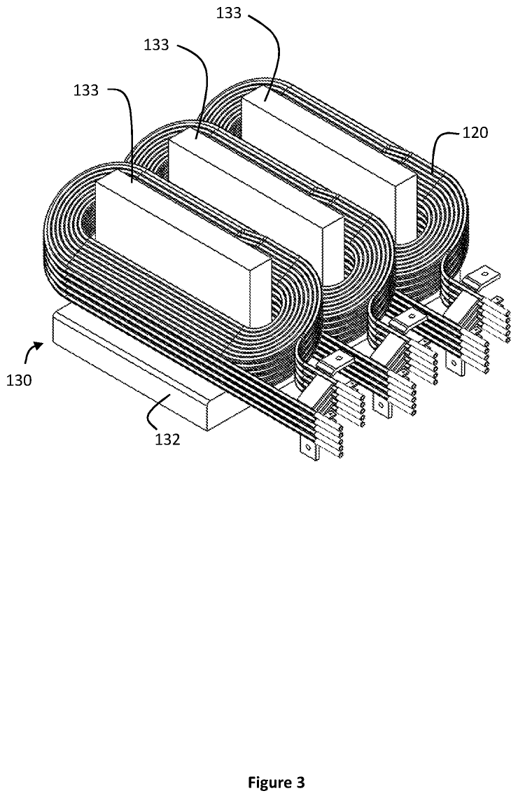

As shown in FIG. 3, the inductors 120 are formed from coils of wire wrapped around magnetic core 130. Specifically, the electromagnetic device 100 has a single magnetic core 130 formed from a ferromagnetic or ferrimagnetic material, such as ferritic steel, with a base 132 that extends along the length L of the duct 102. Finger-like projections 133 extend from the base 132, towards the side surfaces 112, 114. The coils are wrapped around the projections 133, with sufficient turns of wire forming a coil around each of the projections 133. The number of turns depends on the design criteria for the electromagnetic device, but is usually in the range of 50-200 turns. The coils are formed from wire, such as copper wire, or material with similarly good electrical conductivity. The coils are embedded in a glassy silica fibre sleeve, soaked with a resin such as epoxy to give the coil physical protection and electrical insulation. The coils may also be placed into a non-conductive temperature resistant polymer box and cast into a non-conductive temperature resistant rubber.

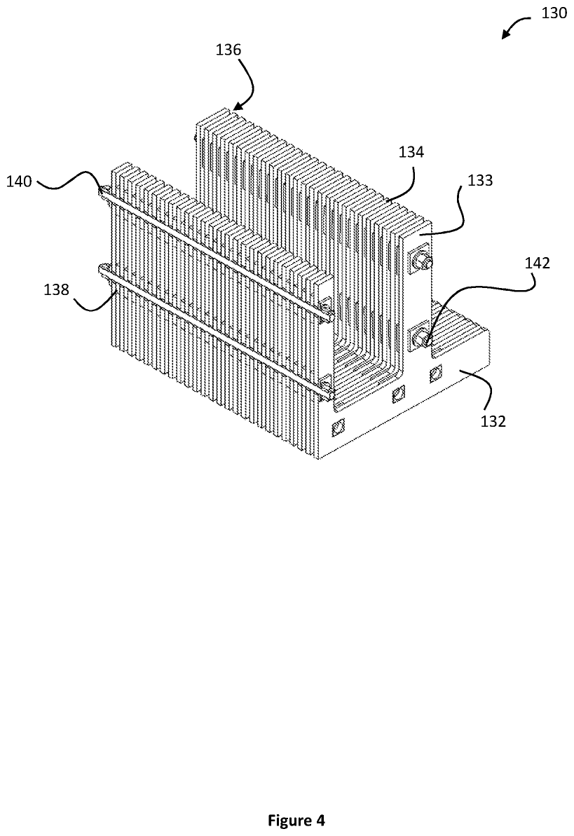

The magnetic core 130 has a laminate construction, as shown in FIG. 4, where thin sheets of magnetic material 134 (such as ferromagnetic or ferrimagnetic material, like ferritic steel) are stacked with air gaps 136 (or other insulating material) in between. Spacers 138 made of an insulating material, such as non-conductive polymer, hold the sheets of magnetic material 134 apart to form the air gaps 136. Holes extend through the projections 133 and base 132, typically passing through the spacers 138. Through these holes, a threaded connecting rod 140 is passed. Fasteners, such as nuts 142, in either end of the connecting rod 140 hold the magnetic core 130 together.

The laminated structure of the magnetic core 130 has been designed to suit the applied current source. The laminated design, where the air gap 136 is around the same thickness as the sheet of magnetic material 134, significantly reduces the total weight of each of the assemblies 116, 118. This is important since the assemblies have to be held in place above and below the duct 102.

The coils extending around neighbouring projections 133 are offset diagonally. That is, the position of a particular coil along a first side of projection 133 is different to the position of the same coil on the opposite side of the projection 133. The position of a particular coil on the first side of projection 133 matches the position of the neighbouring coil on the first side of the neighbouring projection. Likewise, the position of the particular coil on the second opposite side of projection 133 matches the position of the coil on the second opposite side of the neighbouring projection 133.

Inlets 152 and outlets 154 are provided for attachment to a liquid cooling supply. Cooling liquid passes around the inductor coil 120 and optionally the magnetic core 130. The coils generate resistive heat in operation and while the design of the magnetic core has been considered to reduce any currents and therefore waste heat, nevertheless some waste heat will still be produced that is removed by the liquid cooling fluid. The liquid coolant has a low conductivity and is designed to not be hazardous in order to not cause explosion of any exposed liquid aluminium.

FIG. 5 illustrates an electronic circuit 180 which is designed to energise each of the inductors 120a, 120b and 120c in a sequence so as to generate a moving magnetic field which propels a body of non-ferrous molten metal along the duct 102. The electronic circuit 180 takes a mains alternating current supply 182 (which is typically at 380 V-480 V, 50 Hz-60 Hz) and converts it into direct current using input rectifier 184. There is a DC-DC converter 186a, 186b and 186c for each of the inductors 120a, 120b, and 120c fed from the direct current generated by the input rectifier 184. Each DC-DC converter 186a, 186b and 186c generates the pulse required to operate each of the inductors 120a, 120b and 120c and generate the moving magnetic field.

Power to each of the inductors 120 is turned on for a period of between 10 and 10000 milliseconds before being turned off. The inductors 120 are turned on and off in a sequence to generate the desired moving magnetic field. For example, first inductor 120a is turned on generating a magnetic field shown in FIG. 6a, then inductor 120a is turned off and inductor 120b is turned on generating a magnetic field that has moved along the length of the duct 102, as shown in FIG. 6b. Finally, inductor 120b is turned off and inductor 120c is turned on. This generates a magnetic field which has moved further along the length of the duct, as shown in FIG. 6c. This moving magnetic field propels the body of non-ferrous molten metal along the duct in the direction of the moving magnetic field. The process is repeated by turning off inductor 120c and turning on inductor 120a and repeating the cycle. The direction of travel can be changed by reversing the sequence in which the inductors 120a, 120b and 120c are turned on and off.

The applied pulsing rate is around 0.5 to 100 pulses per second. This correlates to the effect that would be expected from a frequency in the range of around 0.16 Hz-33.3 Hz. The higher the pulsing rate the lower the penetration depth, but the higher the interaction of the magnetic field with the molten metal. The ability to vary the pulsing rate allows to adjust the performance of the electromagnetic device 100 to be adjusted to suit different requirements, for example, to suit the needs of circulation or transfer.

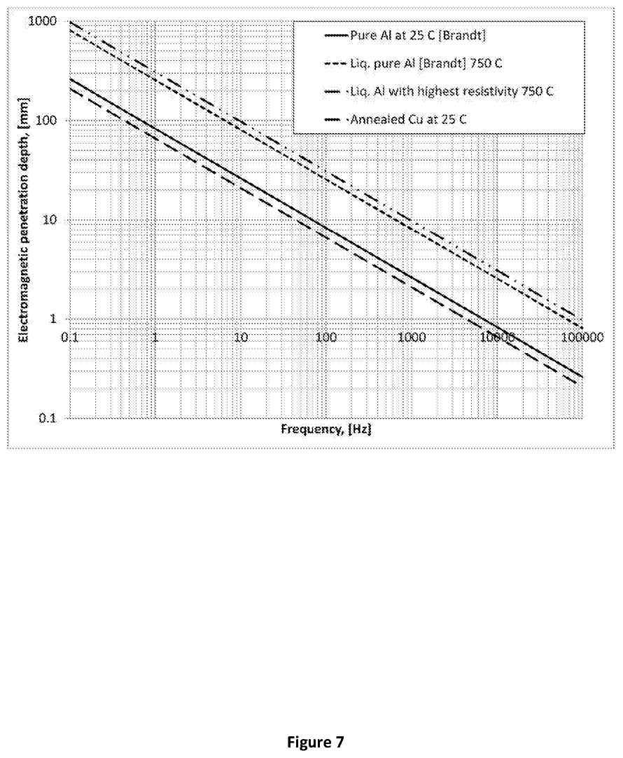

FIG. 7 illustrates the penetration depth of a magnetic field into a number of materials as a function of frequency. As can be seen from FIG. 7, lower frequency pulses that can be generated by the electronic circuit 180 provide for a much a higher penetration depth which can easily be tuned when compared with typical mains frequencies (fixed at 50-60 Hz). This increased penetration depth, combined with a duct geometry which reduces the required penetration depth, allows the inductor assemblies 116, 118 to be spaced apart from the duct 102 to reduce heat loading on the inductors by providing space for more insulation 109 and allowing the inductor assemblies 116, 118 to be physically separated from the duct 102 and insulation 109 for easier maintenance.

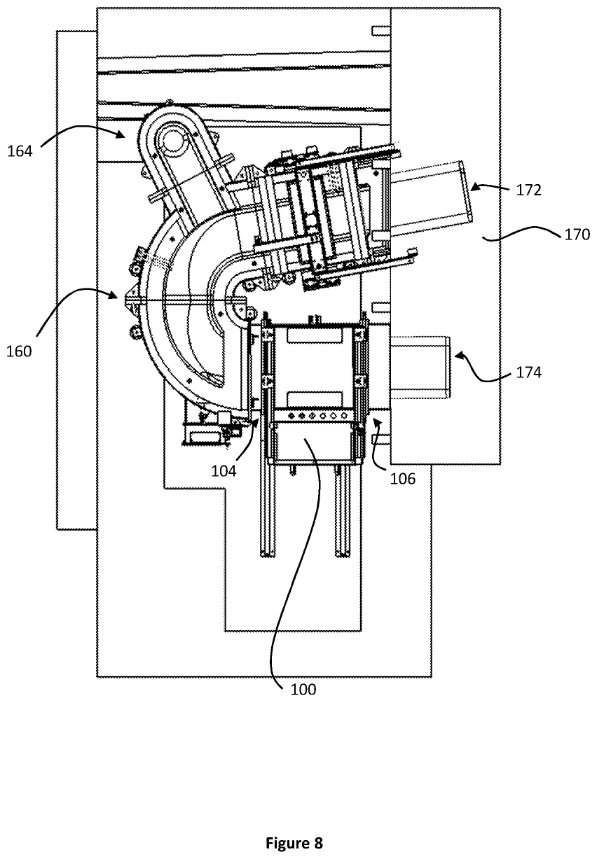

FIG. 8 illustrates a system comprising a vessel 170 for holding a body of non-ferrous molten metal, for example, when melting metal for production or recycling. A channel 160 such as an open-topped launder is connected at a first end to an opening 172 in the vessel 170. The electromagnetic device 100 is connected by its second aperture 106 to a second opening 174 in the vessel 170. In this way, the electromagnetic device being operated as described above is configured to propel the body of non-ferrous molten metal along the duct 102 towards its second aperture 106 into the vessel 170, causing non-ferrous molten metal to circulate in the vessel 170 and back into the channel 160 via opening 172. This acts to stir the molten metal in the vessel helping to make the temperature distribution in the vessel 170 more homogeneous, ensuring thorough mixing of alloys, reducing dross formation and improving melting efficiency.

The channel can also have an outlet 164 with a dam that can allow molten metal to be selectively removed from the channel 160 and the electromagnetic device 100 can pump the molten metal around channel 160 towards the outlet 164. In transfer operations such as this, the electromagnetic device 100 may operate in the opposite direction, propelling the body of non-ferrous molten metal along the duct 102 towards its first aperture 104 and into the channel 160.

Although the invention has been described in certain terms of a particular preferred embodiment, the skilled person will appreciate that there are modifications that could be made without departing from the scope of the claimed invention.

For example, the invention has been shown as having corresponding pairs of inductors 120 and magnetic cores 133 on either side of the duct 104. However, the skilled person will appreciate that only a first inductor assembly may be provided on one side of the duct, either permanently or just during maintenance operations. That is, there does not need to be a second inductor assembly on the other side of the duct. If a second inductor assembly is provided, the skilled person will appreciate that it could have an inductor with a magnetic core, or just a magnetic core by itself.

The invention has been illustrated in terms of three inductors. The skilled person will appreciate that as long as at least two inductors are provided, any number of inductors can be provided which produce the desired moving magnetic field to propel the molten metal along the duct.

Although the inductors have been illustrated as comprising coils, any kind of inductor known to the skilled person could be used instead, such as a flat plate inductor.

The coils have been illustrated as being diagonally offset. However, the coils could be offset in some other arrangement or not offset at all, particularly if the overall length of the device is not critical.

1. An electromagnetic device for pumping, circulating or transferring non-ferrous molten metal, the electromagnetic device comprising:
a duct made of a refractory material, the duct having a first aperture at a first end of the duct and a second aperture at a second end of the duct, the duct configured to convey a body of non-ferrous molten metal between the first and second apertures, the duct configured to enclose the body of non-ferrous molten metal between the first and second apertures, and the duct having opposing first and second external side surfaces;
a first inductor assembly extending adjacent to the first side surface, wherein the first inductor assembly comprises a plurality of inductors arranged along a length of the duct adjacent to the first side surface; and
an electronic circuit configured to generate direct current pulses that energise each inductor of the plurality of inductors in a sequence, so as to generate a moving magnetic field within the body of non-ferrous molten metal which propels the body of non-ferrous molten metal along the duct.

2. The electromagnetic device of claim 1, wherein a cross-section through the duct has a height and a width, wherein the height is defined by a distance between the first and second side surfaces and the height is less than the width.

3. The electromagnetic device of claim 2, wherein the width of the cross-section is at least the width of the inductors of the first inductor assembly.

4. The electromagnetic device of claim 2, wherein the height is based on the penetration depth of the magnetic field.

5. The electromagnetic device of claim 1, wherein the distance between the first inductor assembly and the second side surface is less than the penetration depth of the magnetic field.

6. The electromagnetic device of claim 5, wherein the penetration depth of the magnetic field is at least one of: 50 mm, 100 mm, 200 mm, 300 mm, 400 mm, 500 mm and 1000 mm.

7. The electromagnetic device of claim 1, wherein a cross-section through the duct is substantially rectangular.

8. The electromagnetic device of claim 1, wherein a gap between the body of non-ferrous molten metal and the first inductor assembly is more than one of: 75 mm, 100 mm, 150 mm, 200 mm and 250 mm.

9. The electromagnetic device of claim 1, further comprising a second inductor assembly extending adjacent to the opposing second side surface, wherein the second inductor assembly comprises a plurality of components arranged along a length of the duct adjacent to the second side surface, wherein each of the components is one or more of an inductor and a magnetic core.

10. (canceled)

11. The electromagnetic device of claim 9, wherein each of the inductors adjacent to the first side surface opposes one of the components adjacent to the second side surface.

12. The electromagnetic device of claim 1, wherein each inductor comprises a coil wrapped around a magnetic core, wherein each of the inductors on a side of the duct is wrapped around a single magnetic core that extends along the length of that side of the duct.

13. (canceled)

14. (canceled)

15. The electromagnetic device of claim 11, wherein the single magnetic core comprises a base that extends along the length of the side of the duct and a plurality of projections extending from the base, wherein each coil extends around one of the projections.

16. (canceled)

17. The electromagnetic device of claim 15, wherein the coils extending around neighbouring projections are offset or diagonally offset.

18. (canceled)

19. The electromagnetic device of claim 12, wherein the magnetic core has a laminated structure comprising sheets of magnetic material separated by an insulating material, optionally wherein the insulating material comprises one or more of air, silicates and/or polymers.

20. (canceled)

21. (canceled)

22. (canceled)

23. (canceled)

24. The electromagnetic device of claim 1, wherein the direct current pulses are asymmetrical.

25. The electromagnetic device of claim 1, wherein each direct current pulse has a pulse length in the range of 10 and 10000 milliseconds.

26. The electromagnetic device of claim 25, wherein the electronic circuit generates between 0.5 and 100 direct current pulses per second, preferably 0.1 to 100 direct current pulses per second.

27. The electromagnetic device of claim 1, wherein the inductor assembly is not physically coupled to the duct or to insulation surrounding the duct.

28. (canceled)

29. (canceled)

30. (canceled)

31. A system comprising a vessel for holding a body of non-ferrous molten metal and a channel connected by at least one end to a first opening in the vessel, and an electromagnetic device according to claim 1, wherein the electromagnetic device is configured to cause molten metal to flow along the channel.

32. The system of claim 19, wherein the first aperture of the electromagnetic device is connected to a second opening in the vessel and the second aperture of the electromagnetic device is connected to the channel, wherein the electromagnetic device is configured to propel the body of non-ferrous molten metal along the duct towards the first aperture.

33. (canceled)
